(19) United States
(12) Patent Application Publication
(10) Pub. No.: US 2024/0095551 A1
(43) Pub. Date: Mar. 21, 2024

(54) SYSTEMS AND METHODS FOR SUCCESSIVE FEATURE IMPUTATION USING MACHINE LEARNING

(71) Applicant: Capital One Services, LLC, McLean, VA (US)

(72) Inventor: Michael Langford, Plano, TX (US)

(21) Appl. No.: 17/945,391

(22) Filed: Sep. 15, 2022

(51) Int. Cl. G06N 5/04; G06N 5/02

(52) U.S. Cl. CPC G06N 5/04; G06N 5/022

(57) ABSTRACT

Systems and methods for successively imputing missing feature values using machine learning to sequentially fill in missing feature values in partially-filled datasets, and by using the information in populated records of the dataset. The systems and methods disclosed herein may be useful in many machine learning contexts and application where datasets are missing values.

### FIELD

This disclosure generally relates to machine learning, and in particular, to systems and methods for filling-in missing feature values in partially-filled datasets by utilizing data in populated records of the dataset to estimate the missing feature values by successive imputation using machine learning.

### BACKGROUND

Real-world datasets often contain many missing values, which can create biases and analysis errors, particularly when machine learning models are trained on such datasets. Missing values in datasets may be filled in with new values to reduce such bias and errors and to aid data exploration.

Traditional imputation methods involve eliminating incomplete rows/columns or replacing missing values with guesses, random values, or a mean/median of populated values of the same feature. But such approaches can miss out on potentially useful information that could be derived from other features in the same observation to inform the imputation of the missing value(s).

Accordingly, there is a need for improved systems and methods for feature imputation using machine learning. Embodiments of the present disclosure are directed to this and other considerations.

### BRIEF SUMMARY

The systems and methods disclosed herein may be utilized for successive feature imputation of missing feature values of a dataset using machine learning.

Consistent with the disclosed embodiments, a method is provided for imputing missing values in a dataset using machine learning models. The method may include receiving a dataset having a plurality of features with missing feature values. When not all of the features in the dataset have fully populated feature values, the method may include receiving procedure instructions for populating missing values for a feature of the plurality of features having a first lowest count of the missing feature values and populating the one or more missing features in the dataset using the received procedure instructions. The method may include recursively imputing missing values in the dataset by sorting the dataset by a count of the missing feature values for the plurality of features, determining a data type of the feature in the sorted dataset having the lowest count of missing feature values, selecting, from one or more models, an imputation model corresponding to the determined data type, training the imputation model using feature values corresponding to filled dataset indices of populated values of the feature having the lowest count of the missing feature values, predicting, using the trained imputation model, and based on the feature values corresponding to filled dataset indices, missing values of the feature having the lowest count of the missing feature values, and imputing the predicted missing values into the dataset. The method further may include outputting a filled dataset.

Consistent with the disclosed embodiments, a system is provided that may include a processor and memory comprising instructions that when executed by the processor cause the processor to receive a dataset having a plurality of features with missing feature values. When not all of the features in the dataset have fully populated feature values, the instructions cause the processor to receive procedure instructions for populating missing values for a feature of the plurality of features having a first lowest count of the missing feature values and to populate the one or more missing features in the dataset using the received procedure instructions. The instructions further cause the processor to recursively impute missing values in the dataset by sorting the dataset by a count of the missing feature values for the plurality of features, determining a data type of the feature in the sorted dataset having the lowest count of missing feature values, selecting, from one or more models, an imputation model corresponding to the determined data type, training the imputation model using feature values corresponding to filled dataset indices of populated values of the feature having the lowest count of the missing feature values, predicting, using the trained imputation model, and based on the feature values corresponding to filled dataset indices, missing values of the feature having the lowest count of the missing feature values, and imputing the predicted missing values into the dataset. The instructions cause the processor to output a filled dataset.

Consistent with the disclosed embodiments, a non-transitory computer-readable medium comprising a set of instructions that, in response to being executed by a processor circuit, cause the processor circuit to perform a method. The method may include receiving a dataset having a plurality of features with missing feature values. When not all of the features in the dataset have fully populated feature values, the method may include receiving procedure instructions for populating missing values for a feature of the plurality of features having a first lowest count of the missing feature values and populating the one or more missing features in the dataset using the received procedure instructions. The method may include recursively imputing missing values in the dataset by sorting the dataset by a count of the missing feature values for the plurality of features, determining a data type of the feature in the sorted dataset having the lowest count of missing feature values, selecting, from one or more models, an imputation model corresponding to the determined data type, training the imputation model using feature values corresponding to filled dataset indices of populated values of the feature having the lowest count of the missing feature values, predicting, using the trained imputation model, and based on the feature values corresponding to filled dataset indices, missing values of the feature having the lowest count of the missing feature values, and imputing the predicted missing values into the dataset. The method further may include outputting a filled dataset.

Further features of the disclosed design and the advantages offered thereby are explained in greater detail hereinafter regarding specific embodiments illustrated in the accompanying drawings, wherein like elements are indicated to be like reference designators.

### BRIEF DESCRIPTION OF THE DRAWINGS

Reference will now be made to the accompanying drawings, which are not necessarily drawn to scale, and which illustrate various implementations and aspects of the disclosed technology and, together with the description, serve to explain the principles of the disclosed technology.

FIG. 1A is an illustrative example dataset in which certain record feature values are missing, according to an exemplary embodiment of the disclosed technology.

FIG. 1B is an illustrative example corresponding to the dataset illustrated in FIG. 1A, in which record features have been sorted ascending by the most missing feature values.

FIG. 2A is an illustrative example corresponding to the dataset illustrated in FIG. 1A, in which a missing feature categorical value has been imputed, according to certain implementations of the disclosed technology.

FIG. 2B is an illustrative example corresponding to the dataset illustrated in FIG. 1A, in which a missing binary feature value has been imputed, according to certain implementations of the disclosed technology.

FIG. 2C is an illustrative example corresponding to the dataset illustrated in FIG. 1A, in which another missing binary feature value has been imputed, according to certain implementations of the disclosed technology.

FIG. 2D is an illustrative example of a filled dataset corresponding to the dataset shown in FIG. 1A in which missing continuous feature values have been imputed, according to certain implementations of the disclosed technology.

FIG. 3 is an illustrative flowchart for imputing missing values in a dataset, according to an exemplary implementation of the disclosed technology.

FIG. 4. illustrates simplified hardware and software components that may be utilized in certain exemplary implementations of the disclosed technology.

FIG. 5 is a block diagram of a computing device that may be utilized in the system, in accordance with certain example implementations of the disclosed technology.

FIG. 6 is a flow diagram of a method, according to an exemplary implementation of the disclosed technology.

### DETAILED DESCRIPTION

Missing feature values in datasets are often encoded as placeholders such as “NaNs” or blanks. Such partially-populated datasets can be incompatible with machine learning estimators that assume that all feature values are populated. A non-ideal strategy for using incomplete datasets is to ignore the missing value(s), for example, by discarding entire rows and/or columns containing missing values. However, even incomplete records can provide valuable information for populating the missing values.

Imputation is the process of replacing a missing feature value of a record with an estimate. The disclosed technology provides systems and methods for successively imputing missing feature values using machine learning to sequentially fill in missing feature values in partially-filled datasets, and by using the information in populated records of the dataset. The systems and methods disclosed herein may be useful in many machine learning contexts and may address the shortcomings of traditional methods.

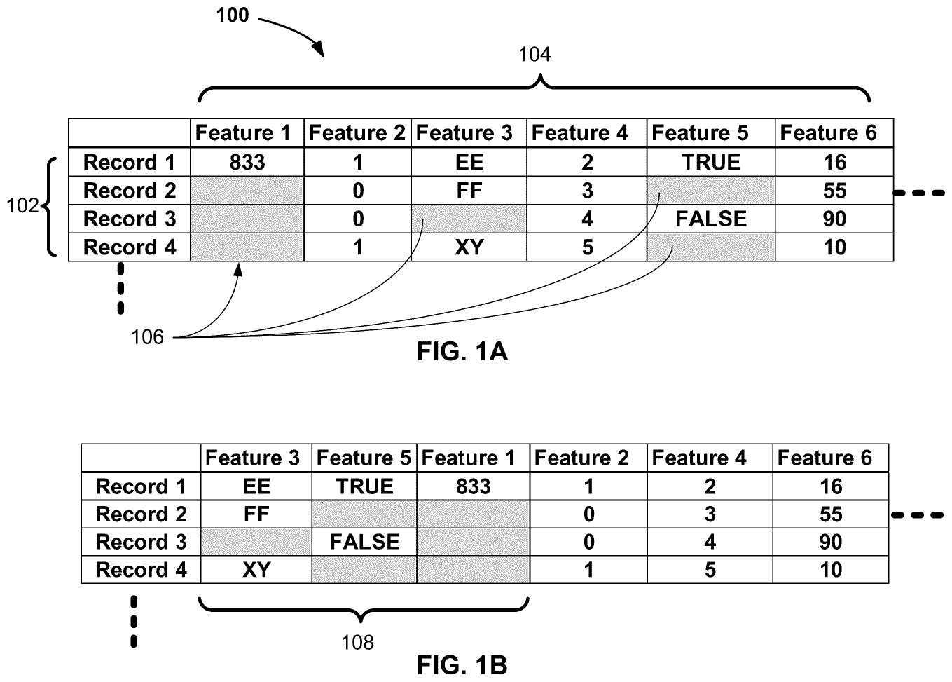

FIG. 1A depicts an example partially-populated dataset 100 that may be used to illustrate certain implementations of the disclosed imputation process. The example dataset 100 may include records 102 having features 104 with missing feature values 106. In this example dataset 100, the various features 104 can include values represented by different data types, such as categorical, variable, and/or binary data types. For example, “Feature 1” and “Feature 6” may be represented by continuous (or integer) variables; “Feature 2” and “Feature 5” may be represented by binary values; and “Feature 3” may be represented by categorical values. The different data types are shown in this example to illustrate how the disclosed technology may handle the different data types. However, it is not a requirement that the dataset has such mixed data types. Also, it should be understood that this is a simplified example. Often, real datasets can have tens or hundreds of missing feature values, and the various features can differ significantly in the number of missing feature values.

FIG. 1B is an illustrative example corresponding to the dataset 100 illustrated in FIG. 1A, in which record features have been sorted by the number of missing feature values 108 in ascending order.

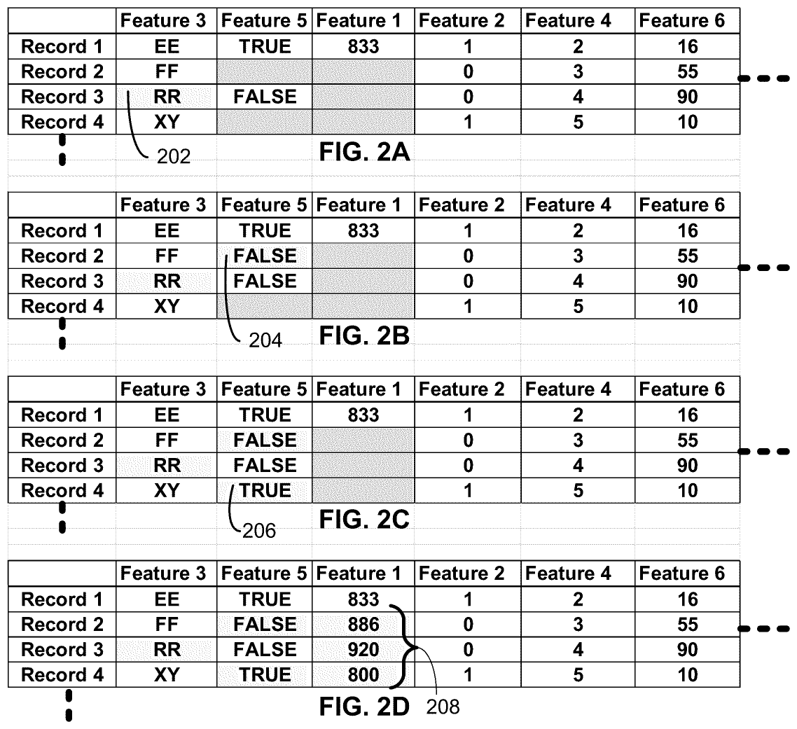

FIG. 2A is an illustrative example corresponding to the dataset 100 illustrated in FIG. 1A, in which a missing (categorical) feature value has been imputed, according to certain implementations of the disclosed technology.

FIG. 2B is an illustrative example corresponding to the dataset illustrated in FIG. 2A, in which a missing (binary) feature value has been imputed, according to certain implementations of the disclosed technology.

FIG. 2C is an illustrative example corresponding to the dataset illustrated in FIG. 2B, in which another missing (binary) feature value has been imputed, according to certain implementations of the disclosed technology.

FIG. 2D is an illustrative example of a filled dataset corresponding to the dataset shown in FIG. 2C in which missing (continuous) feature values have been imputed, according to certain implementations of the disclosed technology.

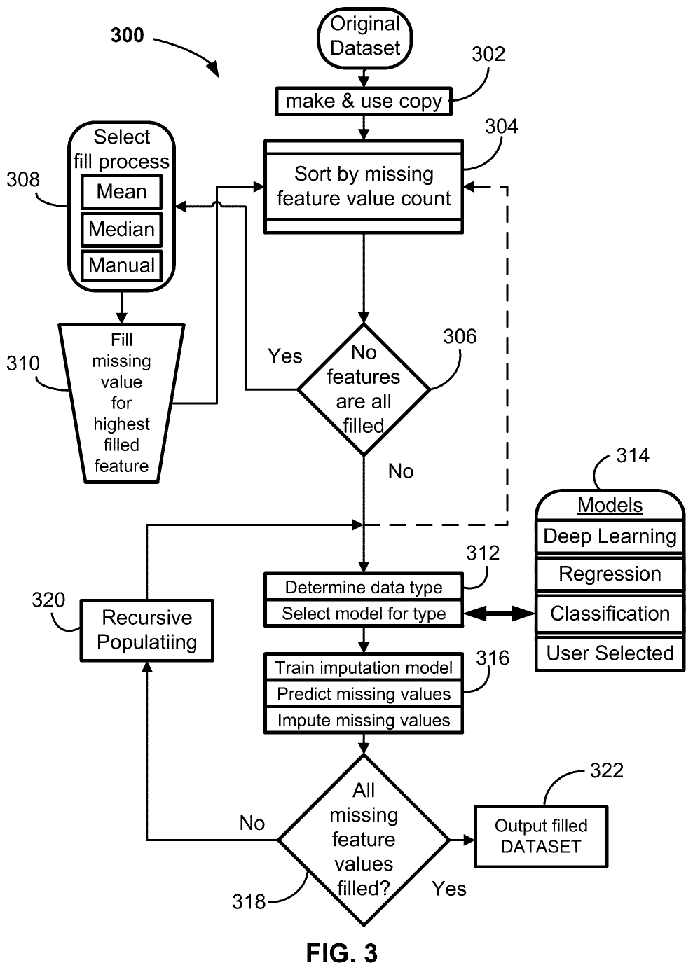

FIG. 3 is an example flowchart 300 of a process for imputing missing values in a dataset, according to an exemplary implementation of the disclosed technology. In certain exemplary implementations, the process(es) illustrated by the flowchart 300 may correspond to certain steps for imputing missing feature values as illustrated in FIGS. 1A-2D as discussed above. The flowchart 300 also provides initial steps for datasets that have no features in which all feature values are filled.

The flowchart 300 of FIG. 3 begins by receiving an original dataset, which may be in tabular format. In step 302, the original dataset may be copied so that work can be performed on the dataset copy without disrupting the original dataset. In step 304, the dataset copy may have its features sorted ascending by the number of missing values in each feature, similar to the sorting process illustrated in FIG. 1B.

In step 306, the sorted dataset copy may be evaluated to determine if there are no features that have all of the values filled. If there are no features that have all of the values filled, the flowchart 300 process may branch to step 308 in which a method (such as mean, median, or manual) can be selected to start the initial filling process. In step 310 the selected method from step 308 may be used to fill the missing feature value(s) for the highest filled feature. For example, if the mean method is selected, the missing feature values(s) for the highest filled feature may be filled-in with the mean of the corresponding filled values of that feature. Likewise, a similar process may be used for the selection of the median method. In certain exemplary implementations, it may be appropriate for a user to manually fill in missing feature values, for example, based on an estimate or other knowledge. However, it should be understood that steps 308 and 310 may be considered initial dataset “priming” so that the rest of the process 300 may utilize machine learning to impute additional feature values.

After completion of step 310, where missing values for the highest filled feature are filled in using the selected process from step 308, the resulting dataset may be returned to step 304 where it may be sorted again, and the decision process in step 306 may be repeated (with the possibility of filling-in additional missing values using steps 308 and/or 310). The resulting dataset may be evaluated again at the decision step 306, and if the resulting dataset has features that are fully populated (i.e., no missing feature values for that particular feature), then the process of the flowchart 300 may move to step 312 where the data type for the next highest filled feature may be determined and a corresponding machine learning model 314 may be selected. For example, if the data type for the next highest filled feature is a categorical variable, a deep learning model may be used. If the data type for the next highest filled feature is a continuous variable, a regression model may be used. If the data type for the next highest filled feature is a binary value, a classification model for binary variable imputation may be used. In certain exemplary implementations, the model may be selected based on an automatic determination of the associated data type. In other implementations, a user-selected model may be used.

In step 316, the selected model 314 may be trained and used to predict and impute the missing feature values. In this step, the indices of the rows of data that are currently filled for the current feature may be extracted and separated from the indices of the rows of data that are not currently filled. These filled indices may then be applied to all rows of data from the features that have already been filled, by previous imputation rounds or from rows not originally containing missing data. The filled data rows may now serve as input data to the selected machine learning model 314, with the current feature's rows used as the targets to train the model. The model may be trained in this way, and then the missing fields in the current feature may be imputed using the predictions from the newly-trained model with input data from the previously filled features.

In decision step 318, the resulting dataset with imputed values (from step 316) may be evaluated to determine if all of the missing feature values are filled. If not, the recursive process of populating the next highest filled feature may be carried out in step 320 by returning the resulting dataset to step 312 for repeating. In certain alternative implementations, the resulting dataset may be returned to step 304, as indicated by the dashed line.

Once this recursive and successive imputation loop 320 has been completed using the machine learning model(s) and feature value imputation has been completed such that all features have their missing values filled, the new filled dataset may be output in step 322. In certain exemplary implementations, the machine learning pipeline used to impute data in the dataset may also be output at step 322, for example, to use in production or for future analysis. For example, a pipeline may list several steps in order and may specify how to impute the training data (sort, fill-in, etc.). The pipeline may be utilized to apply the same process to real data that comes in, and it may provide some consistency for production models.

Given the many different possibilities for sparsely populated datasets, it is unlikely that a given original dataset has missing feature values with associated counts of the missing features separated by one count, as illustrated in the simplified example discussed above with reference to FIGS. 1A-2D. The following example imputation process may illustrate how more complex datasets may be processed using the systems and methods disclosed herein. In this example, Feature 1 may have 10 missing values, which may be the least number of missing values for all the features. The 10 missing values may be filled in using a selected fill process (such as discussed above with respect to step 308 of FIG. 3). In this example, a “mean” process may be selected to fill in the 10 missing values of Feature 1 based on the mean of the populated values of Feature 1.

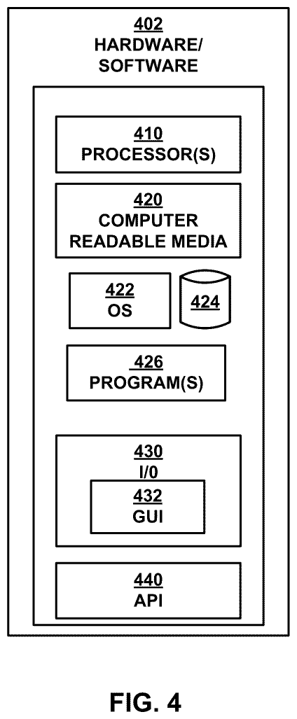

Continuing with this (more complex) example, suppose Feature 5 has 120 missing values, which may be the second least number of missing values. Feature 5 in this example may be a binary data type (for example, true/false, or 0/1) so the classification model may be selected (for example, at step 312 of FIG. 4) and trained (in step 316 of FIG. 3) to map Feature 1's values to Feature 5's known values, then this trained model may be used to predict and impute the remaining 120 missing values of Feature 5. In this example, Feature 1 may have filled values for those 120 missing feature values in Feature 5, so the imputation of Feature 5's missing values can be made using the filled feature values of Feature 1.

Continuing with this (more complex) example, now that Feature 1 and 5 are completely imputed and filled, Feature 3 may be identified as having 487 missing values, which may be the third least number of missing values. In this example, the value type for Feature 3 may be a categorical variable, so a deep learning model may be selected (for example, in step 312 of FIG. 3) to use Feature 1 and Feature 5's originally populated and imputed values to train on Feature 3's known values. Then, this trained deep learning model may be used to predict and impute the remaining 487 missing values of Feature 3. This process may be continued until all values are imputed in all features. In accordance with certain exemplary implementations of the disclosed technology, it may not matter how many values are missing in each feature, provided they are sorted ascending by the number of missing values and are processed in that order.

FIG. 4 is a simple block diagram of example hardware and software 402 components that may be utilized according to an aspect of the disclosed technology, which may include one or more of the following: one or more processors 410, a non-transitory computer-readable medium 420, an operating system 422, memory 424, one or more programs 426 including instructions that cause the one or more processors 410 to perform certain functions; an input/output (“I/O”) device 430, and an application program interface (API) 440, among other possibilities. The I/O device 430 may include a graphical user interface 432.

In certain embodiments, the API interface 440 may utilize real-time APIs. In certain aspects, the API may allow a software application, which is written against the API and installed on a client to exchange data with a server that implements the API in a request-response pattern. In certain embodiments, the request-response pattern defined by the API may be configured synchronously and require that the response be provided in real-time. In some embodiments, a response message from the server to the client through the API consistent with the disclosed embodiments may be in the format including, for example, Extensible Markup Language (XML), JavaScript Object Notation (JSON), and/or the like.

In some embodiments, the API design may also designate specific request methods for a client to access the server. For example, the client may send GET and POST requests with parameters URL-encoded (GET) in the query string or form-encoded (POST) in the body (e.g., a form submission). Alternatively, the client may send GET and POST requests with JSON serialized parameters in the body. Preferably, the requests with JSON serialized parameters use “application/j son” content type. In another aspect, an API design may also require the server to implement the API return messages in JSON format in response to the request calls from the client.

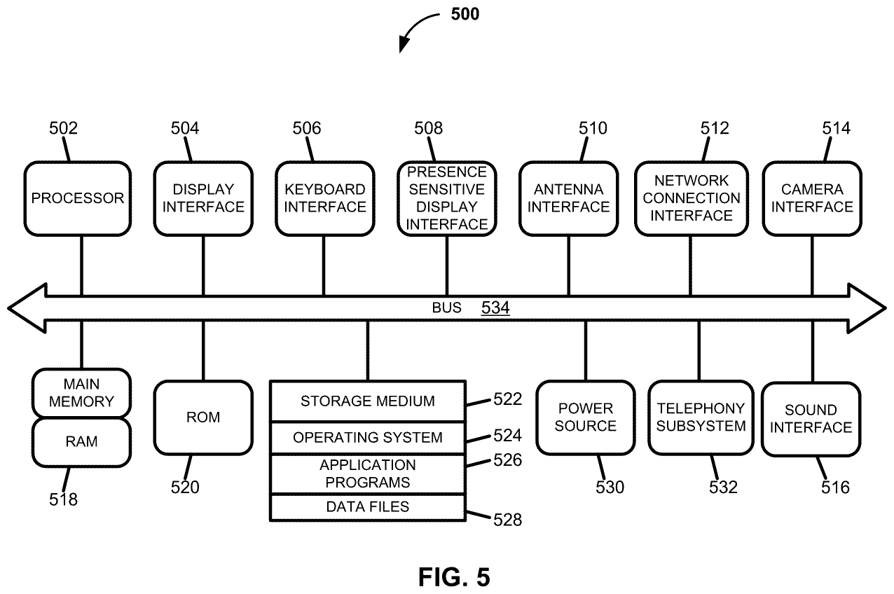

FIG. 5 depicts a block diagram of an illustrative computing device 500 that may be utilized to enable certain aspects of the disclosed technology. Various implementations and methods herein may be embodied in non-transitory computer-readable media for execution by a processor. It will be understood that the computing device 500 is provided for example purposes only and does not limit the scope of the various implementations of the communication systems and methods.

The computing device 500 of FIG. 5 may include one or more processors where computer instructions are processed. The computing device 500 may comprise the processor 502, or it may be combined with one or more additional components shown in FIG. 5. In some instances, a computing device may be a processor, controller, or central processing unit (CPU). In yet other instances, a computing device may be a set of hardware components, such as depicted in FIG. 4.

The computing device 500 may include a display interface 504 that acts as a communication interface and provides functions for rendering video, graphics, images, and texts on the display. In certain example implementations of the disclosed technology, the display interface 504 may be directly connected to a local display. In another example implementation, the display interface 504 may be configured for providing data, images, and other information for an external/remote display. In certain example implementations, the display interface 504 may wirelessly communicate, for example, via a Wi-Fi channel or other available network connection interface 512 to the external/remote display.

In an example implementation, the network connection interface 512 may be configured as a communication interface and may provide functions for rendering video, graphics, images, text, other information, or any combination thereof on the display. For one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 504 may be operatively coupled to a local display. In another example, the display interface 504 may wirelessly communicate, for example, via the network connection interface 512 such as a Wi-Fi transceiver to the external/remote display.

The computing device 500 may include a keyboard interface 506 that provides a communication interface to a keyboard. According to certain example implementations of the disclosed technology, the presence-sensitive display interface 508 may provide a communication interface to various devices such as a pointing device, a touch screen, etc.

The computing device 500 may be configured to use an input device via one or more input/output interfaces (for example, the keyboard interface 506, the display interface 504, the presence-sensitive display interface 508, network connection interface 512, camera interface 514, sound interface 516, etc.) to allow a user to capture information into the computing device 500. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 500 or may be a separate device. For example, the input device may be an accelerometer, a magnetometer, a digital camera, a microphone, and an optical sensor.

Example implementations of the computing device 500 may include an antenna interface 510 that provides a communication interface to an antenna; a network connection interface 512 that provides a communication interface to a network. According to certain example implementations, the antenna interface 510 may utilize to communicate with a Bluetooth transceiver.

In certain implementations, a camera interface 514 may be provided that acts as a communication interface and provides functions for capturing digital images from a camera. In certain implementations, a sound interface 516 is provided as a communication interface for converting sound into electrical signals using a microphone and for converting electrical signals into sound using a speaker. According to example implementations, random-access memory (RAM) 518 is provided, where computer instructions and data may be stored in a volatile memory device for processing by the CPU 502.

According to an example implementation, the computing device 500 may include a read-only memory (ROM) 520 where invariant low-level system code or data for basic system functions such as basic input and output (I/O), startup, or reception of keystrokes from a keyboard are stored in a non-volatile memory device. According to an example implementation, the computing device 500 may include a storage medium 522 or other suitable types of memory (e.g. RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example implementation, the computing device 500 may include a power source 530 that provides an appropriate alternating current (AC) or direct current (DC) to power components. According to an example implementation, the computing device 500 may include a telephony subsystem 532 that allows the device 500 to transmit and receive sound over a telephone network. The constituent devices and the CPU 502 communicate with each other over a bus 534.

In accordance with an example implementation, the CPU 502 has an appropriate structure to be a computer processor. In one arrangement, the computer CPU 502 may include more than one processing unit. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 to execute software programs. Data may be stored in RAM 518, where the data may be accessed by the computer CPU 502 during execution. In one example configuration, the device 500 may include at least 128 MB of RAM, and 256 MB of flash memory.

The storage medium 522 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 500 to access computer-executable process steps, application programs, and the like, stored on removable and non-removable memory media, to off-load data from the device 500 or to upload data onto the device 500. A computer program product, such as one utilizing a communication system may be tangibly embodied in storage medium 522, which may comprise a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices.

Following certain exemplary implementations of the disclosed technology, one or more features may be pre-computed and stored for later retrieval and used to provide improvements in processing speeds.

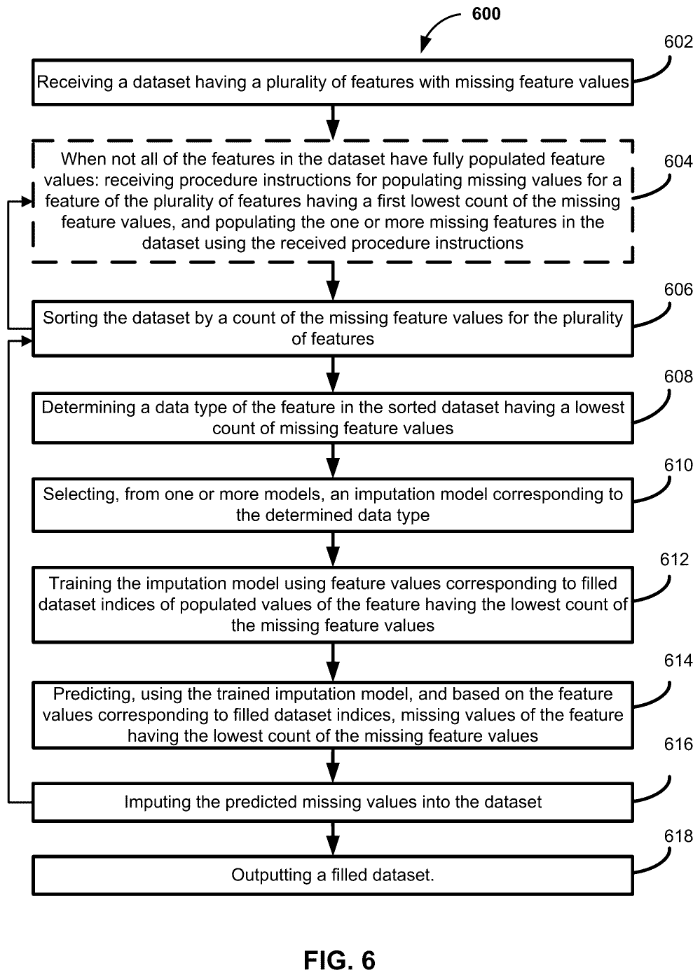

FIG. 6 is a flow diagram of a method 600 according to an exemplary implementation of the disclosed technology. The method 600 may be utilized for imputing missing values in a dataset using machine learning models. In block 602, the method 600 can include receiving a dataset having a plurality of features with missing feature values. For example, a dataset with missing field values, as illustrated in FIG. 1A may be received by the system (as may be represented in FIG. 4 and/or FIG. 5). The dataset shown in FIG. 1A is illustrated in a spreadsheet-like format, but other common tabular formats (plain text, comma-separated values, tab-separated values) or proprietary formats may be suitably provided that the associated dataset features may be sorted by the number of missing values.

In block 604, the method 600 can (conditionally) include receiving procedure instructions for populating missing values for a feature of the plurality of features having a first lowest count of the missing feature values and populating the one or more missing features in the dataset using the received procedure instructions (when not all of the features in the dataset have fully populated feature values). For example, in this step, it may be appropriate for a user to manually fill in missing feature values based on an estimate or other knowledge. However, this (conditional) step may be considered initial dataset “priming” so that the rest of the method 600 may utilize machine learning to impute additional feature values.

In block 606, the method 600 can include sorting the dataset by a count of the missing feature values for the plurality of features. For example, the dataset may have its features sorted ascending by the number of missing values in each feature, similar to the sorting process illustrated in FIG. 1B. In some implementations, block 604 may be repeated when not all of the features in the dataset have fully populated feature values).

In block 608, the method 600 can include determining a data type of the feature in the sorted dataset having the lowest count of missing feature values. In this respect, a corresponding machine learning model may be selected based on the data type. In some implementations, the data type for the lowest count of missing feature values may be pre-determined. In certain exemplary implementations, the dataset may indicate the data type. In certain exemplary implementations, the data type may be automatically detected. Yet in other example implementations, the data type may be manually selected, for example, based on user knowledge.

In block 610, the method 600 can include selecting, from one or more models, an imputation model corresponding to the determined data type. In certain exemplary implementations, if the data type is a categorical variable, a deep learning model may be used. In certain exemplary implementations, if the data type is a continuous variable, a regression model may be used. In certain exemplary implementations, if the data type is a binary value, a classification model for binary variable imputation may be used. In certain exemplary implementations, the model may be selected based on an automatic determination of the associated data type. In other implementations, a user-selected model may be used.

In block 612, the method 600 can include training the selected imputation model using feature values corresponding to filled dataset indices of populated values of the feature having the lowest count of the missing feature values. For example, the selected model may be trained and used to predict and impute the missing feature values. In this step, the indices of the rows of data that are currently filled for the current feature may be extracted and separated from the indices of the rows of data that are not currently filled.

In block 614, the method 600 can include predicting, using the trained imputation model, and based on the feature values corresponding to filled dataset indices, missing values of the feature having the lowest count of the missing feature values. For example, the information in the filled dataset indices may then be applied to other rows of data from the features that have already been filled by previous imputation rounds or from rows not originally containing missing data. The filled data rows may now serve as input data to the selected machine learning model, with the current feature's rows used as the targets to train the model. The model may be trained in this way, and then the missing fields in the current feature may be imputed using the predictions from the newly-trained model with input data from the previously filled features.

In block 616, the method 600 can include imputing the predicted missing values into the dataset. At this point in the method 600, the resulting (imputed) dataset may be evaluated to see if there are still missing feature values (such as blanks, NaN, or other similar indicators) and, if so, the method 600 may return the resulting dataset to block 606 to repeat the process. In block 618, after the dataset has been filled, the method 600 can include outputting a filled dataset.

For example, the resulting dataset with imputed values may be evaluated to determine if all of the missing feature values are filled. If not, the recursive process of populating the next highest filled feature may be carried out by returning the dataset to block 606. In accordance with certain exemplary implementations of the disclosed technology, once this recursive and successive imputation method 600 has been completed using the machine learning model(s) and feature value imputation has been completed such that all features have their missing values filled, the new filled dataset may be output. In certain exemplary implementations, the machine learning pipeline used to impute data in the dataset may also be output, for example, to use in production or for future analysis. The pipeline, for example, may list several steps in order and may specify how to impute the training data (sort, fill in, etc.). The pipeline may be utilized to apply the same process to real data that comes in, and it may provide some consistency for production models.

In certain exemplary implementations, receiving the procedure instructions can include receiving mean instructions, median instructions, mode instructions, and/or a supplied or default value to populate one or more missing features in the dataset.

According to an exemplary implementation of the disclosed technology, the data type can include a category, a continuous variable, or a binary value.

In certain exemplary implementations, the imputation model can include one or more of a deep learning model for categorical variable imputation, a regression model for continuous variable imputation, and a selectable classification model for binary variable imputation.

In certain exemplary implementations, the original dataset may be copied to enable imputing missing values into a copied dataset without modifying the original dataset.

In accordance with certain exemplary implementations of the disclosed technology, one or more of the models may be selected by or received from a user.

In accordance with certain exemplary implementations of the disclosed technology, recursively imputing missing values in the dataset may further include one or more of identifying dataset indices for a feature having the lowest count of the missing feature values and identifying the filled dataset indices for populated values of the feature having the lowest count of the missing feature values.

In certain exemplary implementations, identifying dataset indices can include identifying row indices.

In certain exemplary implementations, sorting the dataset by a count of the missing feature values for the plurality of features can include sorting the dataset in ascending order of the count of the missing feature values.

In certain exemplary implementations, recursively imputing missing values in the dataset may be performed corresponding to the ascending order of the count of the missing feature values.

In certain exemplary implementations, the dataset may be in a tabular format.

According to an exemplary implementation of the disclosed technology, the training can include using populated rows of features having the lowest count of the missing feature values as targets to train the selected imputation model.

Certain exemplary implementations of the disclosed technology may include outputting a machine learning pipeline used for imputing the predicted missing values into the dataset.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. Also, these components can execute from various computer-readable media having various data structures stored thereon. The components may communicate by way of local and/or remote processes such as by a signal having one or more data packets, such as data from one component interacting with another component in a local system, distributed system, and/or across a network such as the Internet with other systems by way of the signal.

Certain embodiments and implementations of the disclosed technology are described above regarding block and flow diagrams of systems and methods and/or computer program products. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above concerning user devices may include mobile computing devices. Those skilled in the art recognize that there are several categories of mobile devices, generally known as portable computing devices that can run on batteries but are not usually classified as laptops. For example, mobile devices can include but are not limited to portable computers, tablet PCs, internet tablets, PDAs, ultra-mobile PCs (UMPCs), wearable devices, and smartphones. Additionally, implementations of the disclosed technology can be utilized with the internet of things (IoT) devices, smart televisions and media devices, appliances, automobiles, toys, and voice command devices, along with peripherals that interface with these devices.

It is intended that each term presented herein contemplates its broadest meaning as understood by those skilled in the art and may include all technical equivalents, which operate similarly to accomplish a similar purpose.

Ranges may be expressed herein as from “about” or “approximately” one particular value and/or to “about” or “approximately” another particular value. When such a range is expressed, another embodiment may include one particular value and/or the other particular value. Similarly, values may be expressed herein as “about” or “approximately.”

The terms “comprising” or “containing” or “including” means that at least the named element, material, or method step is present in the apparatus or method, but does not exclude the presence of other elements, materials, and/or method steps, even if the other elements, materials, and/or method steps have the same function as what is named.

The term “exemplary” as used herein is intended to mean “example” rather than “best” or “optimum.”

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” and “some implementations,” etc., indicate that the implementation(s) of the disclosed technology so described may include a particular feature, structure, or characteristic, but not every implementation necessarily may include the particular feature, structure, or characteristic. Further, repeated use of the phrase “in one implementation” does not necessarily refer to the same implementation, although it may.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Throughout the specification and the claims, the following terms take at least the meanings explicitly associated herein, unless the context dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including,” it is meant that at least the named element, or method step is present in the article or method but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXEMPLARY USE CASE

The disclosed technology may be utilized in many use cases, including but not limited to the exemplary use case of filling in (or imputing) incomplete or missing data fields, as discussed herein with respect to FIG. 1A through FIG. 2D.

In another exemplary use case, the disclosed technology may be utilized to complete a financial record dataset in which certain records have missing or non-compatible data field entries, as illustrated in the highlighted cells of Table 1 below, to arrive at the completed dataset illustrated in Table 2 below. A process similar (or the same) as discussed with reference to FIG. 3 and/or FIG. 6. may be used in this use case, but the intermediate steps (such as copying, sorting, processing, filling missing values, determining data type, selecting model, training model, recursive populating, etc.) are omitted here for clarity.

In this exemplary use case, a plurality of customers with their associated data may be listed in rows, with columns representing features, such as zip code, city, state, minimum income, credit score, credit history, etc. One goal for this use case may be to populate the missing field data with improved estimates, for example, to impute data in the fields that are blank, populated with “NAN,” “unknown,” or feature values that do not correspond with the feature category (such as “14” representing the state for Cust 1).

TABLE 1

| | Zip | City | State | Income | Cred Score | Cred Hist |
|---|---|---|---|---|---|---|
| Cust 1 | 21404 | Annapolis | 14 | >$50K | 700 | 30 month |
| Cust 2 | | Salt Lake | UT | >$100K | unknown | 200 month |
| Cust 3 | NAN | Manassas | | | 840 | 240 month |
| Cust 4 | | Bend | OR | >$5K | | 1 month |

TABLE 2

| | Zip | City | State | Income | Cred Score | Cred Hist |
|---|---|---|---|---|---|---|
| Cust 1 | 21404 | Annapolis | MD | >$50K | 700 | 30 month |
| Cust 2 | 84101 | Salt Lake | UT | >$100K | 820 | 200 month |
| Cust 3 | 20108 | Manassas | VA | >$200K | 840 | 240 month |
| Cust 4 | 97701 | Bend | OR | >$5K | 350 | 1 month |

As illustrated by this use case example, the disclosed technology may improve the accuracy of a dataset before it is used for other downstream applications, which may be impacted negatively if the dataset is incomplete or inaccurate. For example, one downstream application for which the disclosed technology may be applied (and in particular, for this example use case) can include setting a maximum credit limit for a customer based on associated known (and imputed) data. In the (over-simplified) examples shown in Tables 1 and 2 above, the missing (or incorrect) Zip Code feature may be derived and imputed based at least in part on the populated City and/or State feature(s). Similarly, the missing information in the Credit Score feature may be derived and imputed based at least in part on the customer's Income, Zip code, and/or Credit History length.

While this exemplary use case illustrates only a small number of records (rows) and associated features (columns), certain implementations may utilize other features without limit, such as age, gender, location, purchase history, social network interconnections, interests, fields of expertise, work history, etc. Such diverse information may be used to impute missing dataset fields, for example, to enable training and/or refinement of a machine learning model to harvest unknown data based on available data that may otherwise, be too cumbersome, slow, or inaccurate if the dataset is incomplete.

What is claimed is:

1. A computer-implemented method for imputing missing values in a dataset using machine learning models, the method comprising:
receiving a dataset having a plurality of features with missing feature values;
when not all of the features in the dataset have fully populated feature values:
receiving, from a user, procedure instructions for populating missing values for a feature of the plurality of features having a first lowest count of the missing feature values; and
populating the one or more missing features in the dataset using the received procedure instructions;
recursively imputing missing values in the dataset by:
sorting the dataset by a count of the missing feature values for the plurality of features;
determining a data type of the feature in the sorted dataset having a lowest count of missing feature values;
selecting, from one or more models, an imputation model corresponding to the determined data type;
training the imputation model using feature values corresponding to filled dataset indices of populated values of the feature having the lowest count of the missing feature values;
predicting, using the trained imputation model, and based on the feature values corresponding to filled dataset indices, missing values of the feature having the lowest count of the missing feature values; and
imputing the predicted missing values into the dataset; and
outputting a filled dataset.

2. The method of claim 1, wherein the receiving the procedure instructions comprises receiving mean instructions, median instructions, mode instructions, or a user-supplied value to populate one or more missing features in the dataset.

3. The method of claim 1, wherein the data type comprises a category, a continuous variable, or a binary value.

4. The method of claim 1, wherein the imputation model comprises one or more of a deep learning model for categorical variable imputation, a regression model for continuous variable imputation, and a classification model for binary variable imputation.

5. The method of claim 1, wherein the dataset is copied to enable imputing missing values into a copied dataset without modifying an original dataset.

6. The method of claim 1, wherein the one or more models are received from the user.

7. The method of claim 1, wherein recursively imputing missing values in the dataset further comprises one or more of:
identifying dataset indices for a feature having a lowest count of the missing feature values; and
identifying the filled dataset indices for populated values of the feature having the lowest count of the missing feature values.

8. The method of claim 7, wherein identifying dataset indices comprises identifying row indices.

9. The method of claim 1, wherein sorting the dataset by a count of the missing feature values for the plurality of features comprises sorting the dataset in ascending order of the count of the missing feature values, and wherein recursively imputing missing values in the dataset is performed corresponding to the ascending order of the count of the missing feature values.

10. The method of claim 1, wherein the dataset comprises a tabular format.

11. The method of claim 1, wherein the training comprises using populated rows of feature having the lowest count of the missing feature values as targets to train the selected imputation model.

12. The method of claim 1, further comprising outputting a machine learning pipeline used to for imputing the predicted missing values into the dataset.

13. A system, comprising:
a processor and memory comprising instructions that when executed by the processor cause the processor to:
receive a dataset having a plurality of features with missing feature values;
when not all of the features in the dataset have fully populated feature values:
receive procedure instructions for populating missing values for a feature of the plurality of features having a first lowest count of the missing feature values; and
populate the one or more missing features in the dataset using the received procedure instructions;
recursively impute missing values in the dataset by:
sorting the dataset by a count of the missing feature values for the plurality of features;
determining a data type of the feature in the sorted dataset having a lowest count of missing feature values;
selecting, from one or more models, an imputation model corresponding to the determined data type;
training the imputation model using feature values corresponding to filled dataset indices of populated values of the feature having the lowest count of the missing feature values;
predicting, using the trained imputation model, and based on the feature values corresponding to filled dataset indices, missing values of the feature having the lowest count of the missing feature values; and
imputing the predicted missing values into the dataset; and
outputting a filled dataset.

14. The system of claim 13, wherein the procedure instructions comprises mean instructions, median instructions, mode instructions, or a user-supplied value to populate one or more missing features in the dataset.

15. The system of claim 13, wherein the data type comprises a category, a continuous variable, or a binary value, and wherein the imputation model comprises one or more of a deep learning model for categorical variable imputation, a regression model for continuous variable imputation, and a selectable classification model for binary variable imputation.

16. The system of claim 13, wherein the instructions further cause the processor to recursively impute missing values in the dataset by:
identifying dataset indices for a feature having a lowest count of the missing feature values; and
identifying the filled dataset row indices for populated values of the feature having the lowest count of the missing feature values.

17. The system of claim 13, wherein sorting the dataset by a count of the missing feature values for the plurality of features comprises sorting the dataset in ascending order of the count of the missing feature values, and wherein recursively imputing missing values in the dataset is performed corresponding to the ascending order of the count of the missing feature values.

18. The system of claim 13, wherein the training comprises using populated rows of feature having the lowest count of the missing feature values as targets to train the selected imputation model.

19. A non-transitory computer-readable medium comprising a set of instructions that, in response to being executed by a processor circuit, cause the processor circuit to perform a method of recursively imputing missing values in a received dataset by:
sorting the dataset by a count of missing feature values for a plurality of features in the dataset;
determining a data type of the feature in the sorted dataset having a lowest count of missing feature values;
selecting, from one or more models, an imputation model corresponding to the determined data type;
training the imputation model using feature values corresponding to filled dataset indices of populated values of the feature having a lowest count of the missing feature values;
predicting, using the trained imputation model, and based on the feature values corresponding to filled dataset indices, missing values of the feature having the lowest count of the missing feature values; and
imputing the predicted missing values into the dataset; and
outputting a filled dataset.

20. The non-transitory computer-readable medium of claim 19, further comprising receiving procedure instructions comprising mean instructions, median instructions, mode instructions, or a user-supplied value to populate one or more missing features in the dataset, wherein the imputation model comprises one or more of a deep learning model for categorical variable imputation, a regression model for continuous variable imputation, and a selectable classification model for binary variable imputation.
